(19) United States
(12) Patent Application Publication
(10) Pub. No.: US 2010/0097993 A1
(43) Pub. Date: Apr. 22, 2010

(54) System for Effective Position Management Signaling Associated with Mobile Node Moving in Mobile Network, Router, Mobile Node, and Mobile Router

(76) Inventors: Jun Hirano, Kanagawa (JP); Mohana Dhamayanthi Jeyatharan, Singapore (SG); Chan Wah Ng, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(21) Appl. No.: 12/528,417

(22) PCT Filed: Feb. 25, 2008
(86) PCT No.: PCT/JP2008/000332

§ 371 Date: Sep. 8, 2009

(30) Foreign Application Priority Data
Feb. 23, 2007 (JP) 2007-044676

(51) Int. Cl. H04W 40/00

(52) U.S. Cl. 370/328

(57) ABSTRACT

The present invention provides a system and method for achieving fast and efficient location management signaling between a mobile node, which is nested in a mobile network for possibly long periods of time, and a plurality of correspondent nodes and home agents associated with the said mobile node. More particularly, the present invention relates to attaining fast and efficient location management signaling by means of secure delegation of signaling rights to some trusted signaling proxy server in the fixed domain, which does the location management signaling for the mobile node as a signaling proxy for the mobile node. This signaling proxy server discovered is such that it is in the natural path of the care-of test packets and also be able to send the care-of test init packets using MN's care-of address overcoming ingress filtering.

### TECHNICAL FIELD

The present invention relates to the field of packet-switched communication. More particularly, the present invention relates to mobile nodes moving in packet-switched communication network.

### BACKGROUND ART

Many devices today communicate with each other using the Internet Protocol (IP). In order to provide mobility support to mobile devices, the Internet Engineering Task Force (IETF) has developed the “Mobility Support in IPv6 (MIPv6)” (Non-patent Document 1). Basic mobility support is done in Non-patent Document 1 with an introduction of an entity at the home network known as a home agent (HA). Mobile nodes (MNs) register their care-of addresses that they obtain in foreign links with the home agents using messages known as Binding Updates (BU). This allows the home agent to create a binding between the home address (HoA), which is the long-term address obtained in the home link, and care-of address (CoA), which is the temporary address obtained in the access network, of the mobile node. The home agent is responsible to intercept messages that are addressed to the mobile node's home address, and forward the packet to the mobile node's care-of address using packet encapsulation (i.e. putting one packet as the payload of a new packet, also known as packet tunneling).

In addition to providing the basic mobility support, MIPV6 also has another mode where the MN is able to attain route optimization (RO) with certain correspondent nodes (CNs) that support route optimization. Route optimization is achieved by means of proving to the correspondent node that the mobile node identifier, which is the home address in MIPv6, is collocated with the actual location dependent care-of address. When MN provides this proof (by sending a BU message), CN can then route data packets to MN by using the care-of address as the destination address.

This collocation proof between the permanent address and location dependent address is provided by means of a procedure called the Return Routability (RR). The Return Routability (RR) procedure allows the correspondent node to ascertain that the home-address and care-of-address specified in a BU are indeed collocated. In essence, the RR procedure requires the mobile node to obtain two securely generated tokens from the correspondent node prior to sending it a BU. To initiate the RR procedure, the mobile node first sends the correspondent node two different messages: a Home-Test-Init (HoTI) message, and a Care-of-Test-Init (CoTI) message. The HoTI with the mobile node's home-address as the packet source is sent to the correspondent node via the home agent, and the CoTI with the mobile node's care-of-address as the packet source is sent directly to the correspondent node. The correspondent node, upon receiving the HoTI, will reply with a Home-Test (HoT) message that contains a security token, called the Home Keygen Token (HoK), encrypted based on the home address of the mobile node using a private key. The Home-Test (HoT) message will be sent to the home-address of the mobile node. Similarly, the correspondent node, upon receiving the CoTI, will reply with a Care-of-Test (CoT) message that contains a security token, called the Care-of Keygen Token (CoK), encrypted based on the care-of-address of the mobile node using a private key. The Care-of-Test (CoT) message will be sent to the care-of address of the mobile node. Once the mobile node receives both the HoT and CoT messages, it can send the correspondent node a BU containing an Authenticator. This Authenticator is an encrypted checksum of the BU using a key that is a concatenation of the HoK and CoK. In this way, when the correspondent node receives the BU, it can independently calculate the checksum and check that the checksum is identical to that carried in the Authenticator. This verifies that the care-of address and the home address specified in the BU are indeed collocated.

The security design background about this procedure was briefly explained in non-patent document 3. The aim of the RR security design was to overcome spoofing attacks and flooding attacks to some extent. Spoofing attack refers to an attack using some else's home address as its own home address and capturing the data flows of the victim. Flooding attack refers to an attack using someone else's care-of address as its own and flooding the victims network causing denial-of service.

Nevertheless, the RR procedure is still vulnerable to some attacks where the attacker is on the path between the home agent and the correspondent node. Any attacker at the above mentioned position can generate the RR related signaling and capture the session even after the attacker has moved away from the path between the HA and CN. To alleviate this so-called time shifting attacks, non-patent document 1 makes it mandatory that RR signaling should be performed frequently: the time between two return routability signaling should be at most seven minutes.

Although the above discussed high frequency repetitiveness is needed for the return routability procedure, it is still a very widely favored protocol for applications that do not require a very high security level. This is due to two reasons. Firstly, since there is no state maintenance required at CN associated with RR, it is simple and CNs can have simple configurations to support this protocol. Secondly, it is a lightweight protocol compared to other well-known security protocol, such as cryptographically generated addresses (CGA).

With the ever-increasing proliferation of wireless devices, it is foreseeable that a new class of mobility technology will emerge: network mobility, or NEMO, where a whole network of nodes changes its point of attachment in entirety. The IETF is currently developing a solution for network mobility as disclosed in Non-patent Document 2. Here, it is specified that the mobile router (MR) when sending BU to home agent, will specify the network prefix, which the nodes in the mobile network are using. These are specified using special options known as Network Prefix Options to be inserted into the BU. These allow the home agent to build a prefix-based routing table so that the home agent will tunnel any packets sent to destinations with these prefixes to the care-of address of the mobile router.

As far as the MN is concerned, MIPv6 fully solves the RO problem except for the inefficiencies associated with RR. Currently, there are lots of interests within the research community to increase the security level of RR signaling and to reduce the signaling overhead associated with RR, to reduce the hand-off delay in establishing RO, to reduce hand-off delay when binding with the home agents of the MN and to perform media independent handovers. There are some working groups in the IETF such as the Mobile IP Hand-off Signaling Optimization working group (MIPSHOP) and Mobility Optimizations working group (MOBOPTS) working on achieving reduced hand-off delay and optimized MIPv6 respectively. Apart from these problems with roaming MN, when MN and NEMO integrate, some of the above-mentioned problems are further aggravated. This is primarily due to nested tunneling issue in nested NEMO.

The NEMO working group is addressing all the issues associated with NEMO including the MN and mobile network integration issues. The main issues in MN and NEMO integrated scenarios are achieving end-to-end route optimization for the flows associated with the mobile node that require timely delivery of packets, reducing hand-off delay associated with MN, reducing packet losses due to hand-off, power saving mechanisms for roaming MN that may be limited with power resources and band-width efficiency mechanisms where the bandwidth usage for signaling is reduced as far as possible to save the scarce wireless resource. There are many drafts in the NEMO working group that address the RO problem for a MN in a NEMO environment. There are also some drafts that address the hand-off delay optimization and efficient signaling mechanisms. In this report, the primary focus is to discuss mechanisms that could possibly reduce hand-off delay, reduce MN power wastage, reduce hand-off signaling overhead and reduce wastage of scarce wireless bandwidth when possible.

When MN and NEMO are integrated, there are protocols that are currently very much discussed to reduce the hand-off delay. There is one such protocol called the Global HA-HA protocol which is discussed in the non-patent document 4. This protocol achieves reduced hand-off establishment delay at the home agent by means of proxy HAs. This protocol is extremely useful to achieve reduced hand-off signaling delay with the HAs and also achieve route optimization with a CN that particularly does not support route optimization mechanism. It is a very widely accepted fact that reduced hand-off delay can be obtained by hierarchical location management mechanisms that employ two levels of location dependent addressing and this is obtained by deploying mobility anchor points (MAPs). One of the traditional mechanisms that achieve this hierarchical location management is revealed in non-patent document 6 and is called the hierarchical MIPv6 protocol (HMIPv6). Only when the domain under the MAP changes or when the time between two consecutive RR reaches its threshold, a node needs to inform the CNs about its location attached to a MAP. Inside the MAP domain, MN needs to only update the MAP of its current local address configured from its access network. The primary motive here is to achieve reduced hand-off signaling overhead and reduced hand-off delay. As far as power saving of the MN and bandwidth efficiency is concerned, the savings is not very much. Nevertheless, since costly RR signaling to CNs is not directly tied to MN movement, it can be said that the MN power saving and bandwidth efficiency is also slightly improved with the HMIPv6 scheme when compared to MIPv6 scheme. The route optimization is not the primary motive in the HMIPv6 protocol.

Currently there is a new working group in the IETF called the Network-based Local Mobility Management (NetLMM) working group. The primary motive of this group is to provide local mobility management transparently to the roaming mobile node. Basically, when the mobile node enters a NetLMM domain, it configures a CoA from a prefix from the local mobility anchor (LMA) and registers with its CNs and HAs. After that, the MN is not aware of its change of access network and has a single care-of address in the NetLMM domain. The access router of the roaming MN registers the MN's CoA or MN's HoA and its own address at the local mobility anchor. This scheme was designed to further improve the standard HMIPv6 scheme. The main motive of NetLMM is to perform the location registration signaling inside the NetLMM domain via access routers so that the location update signaling originating from a roaming MN is reduced and MN's power efficiency can be increased. Furthermore, since access routers do local registrations, the access network of MN is not too congested with such local registrations and the bandwidth efficiency of the wireless access network of MN is increased. Furthermore, the location update signaling can be performed faster because the wireless media is not used for local registration.

When the MN is in a mobile network and roaming in the NetLMM domain, again there will be some signaling burden in the access network of MR as well as the NEMO network. Nevertheless, the signaling load is slightly reduced because NetLMM reduces the MR's signaling burden, as the MR is not aware that it is roaming or changing access networks inside the NetLMM domain. From the above discussion it is clear, a lot effort is given to reducing signaling load and reduced hand-off delay in addition to route optimization.

There can be a scenario where the MN enters a mobile network deployed in a car, train, ship or bus and be connected there for long periods of time. In such a case, although the care-of address of MN may not change for long periods, when MN uses the RR procedure for secured binding cache creation process at the CNs, it needs to perform RR signaling as often as mentioned previously (the maximum interval between two RR is seven minutes). Due to this, many problems arise. The primary problem is that this RR signaling originating from MN that is nested behind a single or multiple MRs has the tunneling overhead and tunneling delay problem. The signaling packets from a MN that is nested are usually tunneled and this causes the delay in establishment of the secured binding cache entry (BCE) at the CNs. Furthermore, these signaling packets have to traverse via the access network of the MN which is the NEMO network and the wireless access networks of one or a plurality of upstream MRs. This cause delays because wireless bandwidths are smaller and are prone to more losses due to the vulnerability of the wireless medium. Another problem is that if many MNs enter the mobile network at the same time and be attached to the mobile network for long periods, then their RR signaling packets may be time synchronized (RR signaling performed simultaneously for all the mobiles). This causes collisions of the RR signaling packets and if re-transmission is allowed, this further creates delay. Furthermore, roaming MNs can be having low power levels and they have to waste there energy resources on signaling that is not really involved with them changing the CoAs and hence can be a wastage. Finally, scarce wireless bandwidth associated with NEMO as well as the wireless access networks of the upstream MRs will be wasted for such signaling and this reduces the bandwidth efficiency of wireless networks. It is advantageous to have schemes that can reduce the RR signaling issues for such a scenario where the MN is nested in a mobile network for long periods of time.

In Patent Document 1, there is provided a method and a system where a proxy node in the Internet Service Provider (ISP) where the MN is currently in carries out the location registration signaling for a non-mobile IP aware node that has Mobile IP version 4 (MIPv4) implementations. Location registration via a proxy is done for a MN roaming and getting attached to different fixed access routers and it is not for the MN and NEMO interaction scenario. This method is such that the proxy agent locates the home agent and performs the BU at HA and also does the BU registration at CNs. Since it is a MIPv4 scheme, RR signaling is not used. The proxy-signaling agent will intercept all the signaling as well as the data packets and pass the data packets to the non-mobile IP aware node. The motive here is to give mobile IP features for a non-mobile IP node. The problems with this scheme is that this is not favored for a MN in a nested NEMO scenario because if the MIPv6 MN derives its prefix from the home network then the signaling proxy agent will have to look deeper into the multiple encapsulated packets to get the relevant signaling packets. Furthermore, the proxy-signaling agent has to intercept all the data packets for the non-MIP node and forward it to non-MIPv4 MN. This increases the processing load on the MIPv4 signaling proxy.

In Patent Document 2, there is provided a method where the foreign agent or the access router carries out the location registration signaling for the MN. For the scenario given in the document, the access router does location registrations at the MAP and the HA. The problem with this scheme is that it may not be ideally suited for a MN that is nested in a mobile network. This is because, the access router may not be able to inspect the RR signaling packets that may be encapsulated in multiple levels in proportion to the number of tunneling levels. Moreover, if the MN is moving fast then the access router needs to change and new signaling proxies may have to be re-assigned and consequently proxy transfer signaling will be high.

In Patent Document 3, there is given a method and a system where a router called the vehicle proxy location register (VPLR) that has MIPv6 implementations carries out the proxy location registration signaling for a MN that is embedded inside the vehicle and directly connected to the above mentioned VPLR. In this method, the VPLR informs the MN that it can carry out the proxy signaling. After that, the MN gives the BU packets to be sent to its CNs and HA. Then the VPLR will send these packets to MN's HA and CNs. The problem with this scheme is that it is not ideally suited for a nested NEMO environment. If one assumes that the VPLR is a MR, then the following problems will exist. The first issue is that, delay in RR and BU signaling due to congestion in the access network of MR when MR carries out simultaneous proxy signaling for many MNs. The second issue is that the proxy RR and proxy BU signaling packets still have to go through tunneling procedure (i.e. MR-HA tunnel). The third issue is that the bandwidth resources are wasted in MR's access link to support such signaling.

[Patent Document 1] Greis, M. and Faccin, S., “A method of providing mobile IP functionality for a non mobile IP capable mobile node and switching device for acting as a mobile IP proxy”, WIPO Patent International Publication number WO 2004/010669 A2, 29 January 2004.

[Patent Document 2] Patel, A., Leung, K. and Dommety, G., “Methods and Apparatus for achieving route optimization and location privacy in an IPv6 network”, WIPO Patent International Publication number WO 2006/012511 A1, 2nd Feb. 2006.

[Patent Document 3] Gotoh, F., Hamasaki, R. and Maeda, M., “Mobile Communication System with a Proxy Location Registration Option”, Patent International Publication number WO 2004/070997 A2, 19 Aug. 2004.

[Non-patent Document 1] Johnson, D. B., Perkins, C. E., and Arkko, J., “Mobility Support in IPv6”, Internet Engineering Task Force (IETF) Request For Comments (RFC) 3775, June 2004.

[Non-patent Document 2] Devarapalli, V., et. al., “NEMO Basic Support Protocol”, IETF RFC 3963, January 2005.

[Non-patent Document 3] Nikander, P., Arkko, J., et. al, “Mobile IP version 6(MIPv6) Route Optimization Security Design”, Vehicular Technology Conference, 2003.

[Non-patent Document 4] Thubert, P., Wakikawa, R., et. al., “Global HA HA protocol”, IETF Internet Draft: draft-thubert-nemo-global-haha-01.txt, Oct. 15, 2005.

[Non-patent Document 5] Raman V., et. al., “A protocol for network based Localized Mobility Management”, IETF Internet Draft: draft-raman-netlmm-protocol-00.txt, February 2006.

[Non-patent Document 6] Soliman, H., et. al., “Hierarchical Mobile IPv6 Mobility Management (HMIPv6)”, Internet Engineering Task Force (IETF) Request For Comments (RFC) 4140, August 2005.

From the discussion of the related arts it is clear that for the scenario where MN is nested behind a single or plurality of MRs and being attached to a particular NEMO network for long periods of time there is no single scheme that provides an efficient location management solution. All the related art schemes were designed for a single roaming MN and there was no particular design for MN and NEMO interaction scenario.

### DISCLOSURE OF THE INVENTION

It is thus an object of the present invention to overcome or at least substantially ameliorate the afore-mentioned disadvantages and shortcomings of the related art. Specifically, it is an object of the present invention to achieve reduced location update signaling for MN that is nested inside a NEMO network for long periods, by delegating its signaling rights to some server in the fixed infra structure that can easily and efficiently capture the return routability (RR) packets and generate them without bypassing ingress filtering.

In order to achieve the foregoing object, according to the present invention, it is provided in a preferred embodiment of the present invention a system of communication nodes in a packet switched data communication network including one or more mobile nodes (MNs), one or more mobile routers (MRs), one or more home agents of the above said MNs and MRs and a signaling proxy server functionality which can be placed in any router, such that when MN is inside a NEMO or nested NEMO network for long periods the MN delegates its signaling rights to a router in the fixed network with the above mentioned signaling proxy functionality. The arrangement being such that this router/server with signaling proxy functionality is in the direct path of the care-of test packets from correspondent node (CN) and also this router can generate the care-of test init packets using MN's care-of address overcoming ingress filtering.

In a preferred embodiment of the present invention, the signaling proxy server mentioned previously has a specific functionality such that it sends return routability signaling to CNs as a true signaling proxy for the MN without the CN knowing about it. It also sends a proxy binding update (BU) to MN's home agent where the home agent may know that this BU is coming from a signaling proxy server. The signaling proxy server only does the location management signaling and the MN processes the data packets.

In another preferred embodiment of the present invention, the first step used for delegation mechanism is such that, the MN sends a delegation request to the MR to which it is directly attached. This delegation request message has the number of CNs MN is communicating with and the number of home agents the MN has.

In yet another preferred embodiment of the present invention, the second step used for delegation mechanism is such that, the MR can look into its delegated data base entries and decide on the number of CNs and HAs for which it can assign the signaling proxy server and informs these values to the MN via the delegation request reply. In this reply the MR may also inform the signaling proxy server's public key or some symmetric key.

In yet another further preferred embodiment of the present invention, the third step used for delegation mechanism is such that, the MN once it gets a positive reply from MR, will construct the delegation message to the signaling proxy server informed by the MR. In this delegation message, the MN attaches a certificate, MN's important home agent address, MNs other home agent addresses, MN's correspondent node addresses, and the delegation lifetime. The above mentioned certificate may have a value which is a cryptographic cipher created using MN's home address, MN's care-of address and the signaling proxy server's public key encrypted by the key MN shares with its HA.

In another preferred embodiment of the present invention, the method used by the signaling proxy server to send the proxy BU to MN's home agent is such that it sends the certificate given by MN, a signature and the delegation lifetime. The signature mentioned can be created using the signaling proxy server's private key.

In an alternate preferred embodiment of the present invention, the signaling proxy server previously mentioned can well be the home agent of the mobile access router of MN.

In a preferred embodiment of the present invention, a system comprising of NEMO basic type of MRs and MIPv6 type of MNs, where the above said MNs may well be nested behind one or a plurality of such MRs and using the delegation mechanism outlined previously and delegating the signaling rights to the mobile access router's home agent. It is assumed that the prefix of the care-of address given to CN is obtained from MN's access router's home network.

In a preferred embodiment of the present invention, a system comprising of MRs, MNs and the home agents of these in a global HA-HA overlay network, where the above said MNs may well be nested behind one or a plurality of such MRs and using the delegation mechanism outlined previously and delegating the signaling rights to the mobile access router's home agent. It is assumed that the prefix of the care-of address given to CN is obtained from MN's access router's home network.

In a preferred embodiment of the present invention, a system comprising of MRs, MNs in a NetLMM network, where the above said MNs may well be nested behind one or a plurality of such MRs and using the delegation mechanism outlined previously and delegating the signaling rights to the mobile access router's home agent. It is assumed that the prefix of the care-of address given to CN is obtained from MN's access router's home network.

In yet another preferred embodiment of the present invention, an apparatus associated with the signaling proxy server is such that it has a packet processing mechanism. The mechanism is such that if it receives a packet for MN to which it is a signaling proxy, it will further look at the mobility header. If there is a mobility header, then it will extract the relevant RR tokens. If there is no such mobility header it will process the packet normally.

In yet another preferred embodiment of the present invention, an apparatus associated with the home agent of MN is such that when it knows that its MN has delegated it signaling rights is such that, it will look at the destination address and if it is for such a MN and the packet has mobility header, it will tunnel it to the signaling proxy server address.

In an alternate preferred embodiment of the present invention, the signaling proxy server mentioned previously can well be a server that is placed throughout the ISPs and discovered using the care-of address of MN. An anycast address is constructed using the prefix of the care-of address to discover this server. The server can be discovered by the MN or by the MR, which is directly attached to the MN.

In a preferred embodiment of the present invention, a system comprising of MRs and MNs in a NEMO and HMIPv6 combined scenario, where the above said MNs may well be nested behind one or a plurality of such MRs and using the delegation mechanism outlined previously and using the CoA based discovery to locate the signaling proxy server. This is done by locating the server using an anycast address configured from the prefix of the care-of address given to the CN.

In a preferred embodiment of the present invention, a system comprising of MRs and MNs in a NetLMM scenario, where the above said MNs may well be nested behind one or a plurality of such MRs and using the delegation mechanism outlined previously and using the CoA based discovery to locate the signaling proxy server. This is done by locating the server using an anycast address configured from the prefix of the care-of address given to the CN.

In another preferred embodiment of the present invention, a system comprising of MRs and MNs in a Global HA-HA scenario, where the above said MNs may well be nested behind one or a plurality of such MRs and using the delegation mechanism outlined previously and using the CoA based discovery to locate the signaling proxy server. This is done by locating the server using an anycast address configured from the prefix of the care-of address given to the CN.

In yet another preferred embodiment of the present invention, a system comprising of MRs and MNs in a NEMO RO scenario, where the above said MNs may well be nested behind one or a plurality of such MRs and using the delegation mechanism outlined previously and using the CoA based discovery to locate the signaling proxy server. This is done by locating the server using an anycast address configured from the prefix of the care-of address given to the CN. This NEMO RO scenario is such that the care-of address given to CN is the top-level mobile router care-of address.

In yet another preferred embodiment of the present invention, the proxy BU signaling sent to the MN-HA disclosed can be done transparently to MN′HA.

The present invention has the advantage of reducing location update signaling for MN that is nested inside a NEMO network for long periods.

### BRIEF DESCRIPTION OF THE DRAWINGS

FIG. 1 shows the message sequence chart (MSC) associated with the main invention where an appropriate server in the fixed infra structure does the proxy location registration according to a preferred embodiment of the present invention;

FIG. 2 shows the proxy location registration delegation request and delegation request reply messages according to a preferred embodiment of the present invention;

FIG. 3 shows the proxy location registration delegation message according to a preferred embodiment of the present invention;

FIG. 4 shows the proxy binding update message from the proxy location registration server to the home agent of the mobile node according to a preferred embodiment of the present invention;

FIG. 5 shows the network diagram of the first variation of the main invention where the home agent of the MN's mobile access router does the proxy location registration according to a preferred embodiment of the present invention;

FIG. 6 shows a MSC of the first variation of the main invention being deployed in a simple MIPv6 and NEMO basic support integration scenario according to a preferred embodiment of the present invention;

FIG. 7 shows a MSC of the first variation of the main invention being deployed in a NEMO Global HA-HA scenario according to a preferred embodiment of the present invention;

FIG. 8 shows a MSC of the first variation of the main invention being deployed in a NEMO NetLMM scenario according to a preferred embodiment of the present invention;

FIG. 9 depicts the flow chart associated with the signaling proxy in the first variation of the main invention according to a preferred embodiment of the present invention;

FIG. 10 depicts the flow chart associated with the MN's home agent in the first variation of the main invention according to a preferred embodiment of the present invention;

FIG. 11 shows the network diagram of the second variation of the main invention according to a preferred embodiment of the main invention;

FIG. 12 shows the MSC of the second variation of the main invention where a proxy signaling server that is discovered using the MN's care-of address given to the CN does the proxy location registration according to a preferred embodiment of the present invention;

FIG. 13 shows the MSC of the second variation of the main invention in a NEMO and HMIPv6 scenario according to a preferred embodiment of the present invention;

FIG. 14 shows the network diagram of the second variation of the main invention being deployed in a NEMO NetLMM scenario according to a preferred embodiment of the present invention; and

FIG. 15 shows the MSC of the second variation of the main invention when deployed in a NEMO RO scenario according to a preferred embodiment of the present invention.

### BEST MODE FOR CARRYING OUT THE INVENTION

To overcome the discrepancies outlined in the background, the present invention describes a method where a signaling proxy in the fixed infrastructure is chosen such that RR and BU signaling associated with MN need not go via the wireless media, multiple tunnels and waste narrow wireless bandwidth in the access networks of the upstream MRs. Furthermore, the proxy signaling agent is chosen such that it can directly intercept Care-of test (CoT) message associated with RR and generate proxy care-of test initiation (CoTI) message to CN bypassing ingress filtering. Furthermore, the signaling proxy is chosen such that the proxy-signaling server need not be re-chosen even when the MN is moving. Basically, the signaling agent need not change although MN's NEMO or MN's nested NEMO is moving. This reduces the delegation-signaling overhead and possibly helps in attaining a long-term signaling proxying mode establishment. Another core aim of the invention is to be applicable in future possible core NEMO systems such as the NEMO NetLMM scenario, NEMO global HA-HA scenario, NEMO HMIPv6 scenario and NEMO RO scenario.

Here, the present invention will be disclosed or described by embodiments believed to be the most practical and best. However, it is obvious to those skilled in the art that various modifications can be made without departing from the concept of the present invention with regard to the details of design matters or parameters.

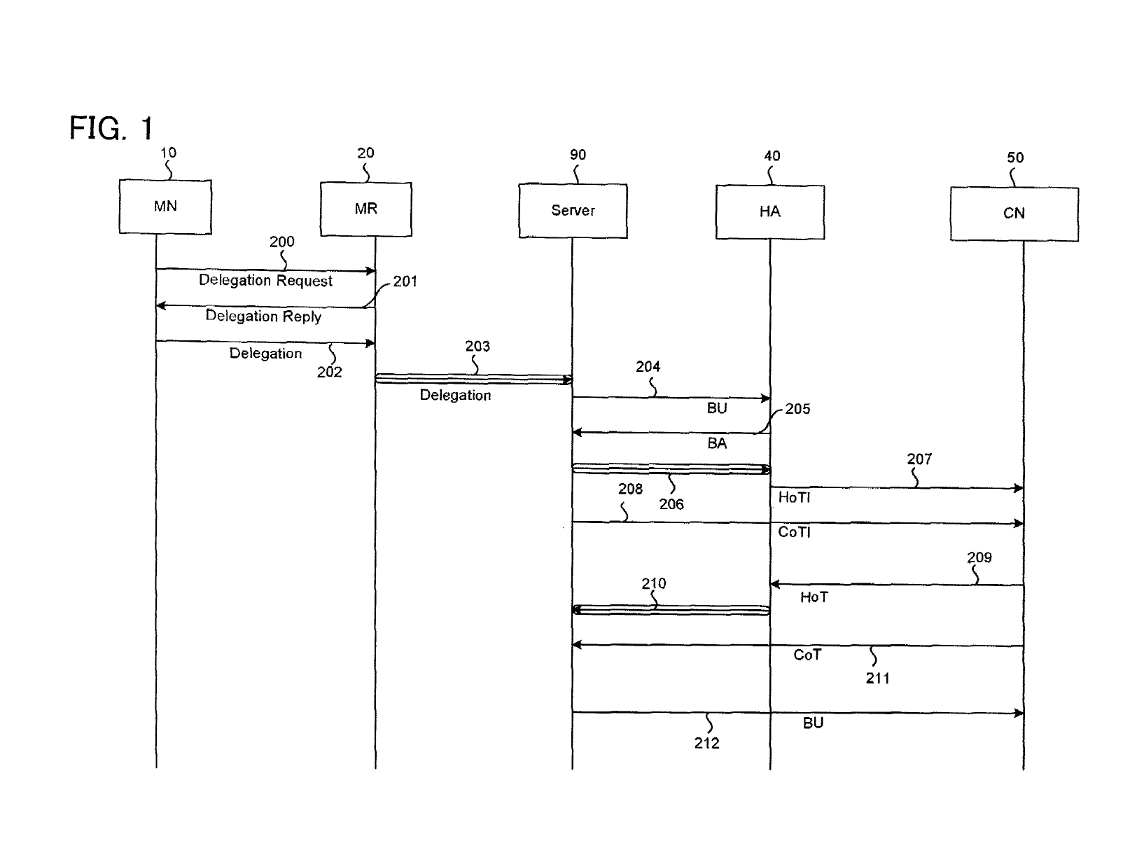

FIG. 1 shows the message sequence chart (MSC) of the main invention according to a preferred embodiment. MN 10, which preferably has at least MIPv6 implementations, is nested behind MR 20 and possibly wants to be attached there for long periods of time. Server 90 is a router in the fixed infra structure, which is capable of doing proxy signaling for MN 10, and can also be called signaling proxy agent or signaling proxy server. HA 40 is the home agent of MN 10 and CN 50 is the node with which MN 10 is communicating. MN 10 can be possibly in a low power mode and knowing that it will be in the vehicle for long periods, decides to delegate its signaling rights to some server in the fixed infrastructure. Such delegation of signaling rights is especially useful for scenarios where the MN's care-of address does not change and the MN is reaching low power levels while roaming. MN 10 sends a delegation request message 200 to MR 20. MN 10 possibly trusts MR 20 since it is roaming inside the mobile network of MR 20 for long periods of time. MR 20 will send a delegation reply based on the availability of a signaling proxy agent. MR 20 may preferably discover the suitable signaling proxy agent for MN 10. This delegation reply 201 may preferably have the security key of the signaling proxy server and the server address, if MR 20 is able to locate one such server. Once a favorable reply is obtained from MR 20, MN 10 sends a delegation message 202 to the signaling proxy server via a tunnel to its own home agent (not shown explicitly in the FIG. 1). If MR 20 is attached to a foreign link, this message will be further tunneled and the message 203 will reach the signaling proxy server 90. Alternatively, MN 10 may just send the delegation parameters to MR 20 and MR 20 may send the delegation message to the signaling proxy server 90. The advantage of this alternate method is that the delegation message need not go via the MN-HA tunnel. Nevertheless, this increases the processing burden at MR 20.

It is important to understand this signaling proxy server is chosen from those which can directly intercept RR packets that are sent to MN's CoA from CN. Direct interception means the care-of test (CoT) packets can be intercepted without any tunneling procedure and this implicitly means intercepting these packets via the shortest path. Furthermore, this signaling proxy is chosen such that one need not change this often because as it can be seen from FIG. 1 that the delegation establishment also incurs some signaling overheads and this should be possibly reduced in an efficient design.

Once the server 90 gets the delegation message 203, it will construct the appropriate proxy BU message 204 to be transmitted to HA 40. This proxy BU message will preferably contain the certificate issued by MN 10, as well as a signature from the server 90 so that the server 90 can provide some authorization to the HA 40. When HA 40 receives this proxy BU message, HA 40 will verify the certificate and signature. If these are valid, HA 40 will create a BCE and will also note that this registration is a proxy registration being sent from server 90 of a particular address. The proxy BU message validity at HA 40 is performed by decrypting the certificate and preferably using the public key of server 90 found in the certificate to verify the signature which is attached by the server 90.

Once such verification has been done and it is successful, HA 40 will send the BA 205 to the server 90. The server 90 can possibly exchange a short-term key to establish BU and BA with HA 40 when it is in this proxying mode. After getting the positive acknowledgement from HA 40, the signaling proxy agent, which is server 90, will go into full proxy mode and send RR signaling to the CN 50. Server 90 will construct the home test Init (HoTI) message 207 and CoTI message 208 and will send to the CN. The HoTI message 207 will be constructed using the home address of MN 10 and will be encapsulated in a tunnel to HA 40. The CoTI message 208 will be constructed using the care-of address of MN 10 as the source address. It is essential that the HoA and CoA of MN 10 be given to the Server 90 so that it can construct these packets. These addresses will be given via the delegation message 202 to the server 90. Once the CN 50 receives these packets 207 and 208, it will generate the home key generation token (HoK) and send HoK via HoT and generate care-of key generation token (CoK) and CoK send it via CoT. These messages are shown as 209 and 211 in FIG. 1. The HoT message 209 will reach, HA 40. HA 40 will inspect this and instead of tunneling HoT 209 to the CoA of MN 10, HA 40 will tunnel HoT packet 209 to server 90. Server 90 will get both the tokens mentioned previously and will generate the binding key as in the MIPv6 standards and will send the BU 212 to CN 50.

From the above explanation, it can be seen that a trusted server for performing proxy signaling is preferably identified by using a trusted node such as MR 20 or by some other means. This proxy-signaling agent is chosen such that it can naturally generate CoTI messages using MN's CoA and overcoming ingress filtering. Moreover, it is preferably placed in a position such that it can directly intercept any CoT message sent by CN. The CoT message can be intercepted via the most optimized path. The advantage of such a server is that RR signaling can be done quickly because the server is in the fixed network infrastructure. Furthermore, the server need not change often although MN's nested NEMO is changing and that is advantageous. In this system, no new functionality is required on CN, which is advantageous as far as scalability is concerned. This new protocol needs to be understood by MN, MR, signaling proxy server and the HA of MN. The changes in MN and MR to support this are minimal. Only the signaling proxy server needs to have more changes to support this.

Another important feature of the present invention is that, there are no major security risks with this method. MN 10 trusts MR 20 since the MN 10 is inside the mobile network of MR 20 for long periods. MR 20 would preferably help in discovering a trusted signaling proxy for MN 10. Thus, signaling proxy is discovered by means of some hierarchical trust architecture. Another striking feature of this is that, only signaling rights are delegated. Data packets are still forwarded directly to MN. This reduces the burden on the signaling proxy server. In the scenario where the server becomes compromised and turn malicious, MN may not be receiving data packets. In such cases, MN can start sending the RR signaling packets itself. It can preferably inform MN-HA not to accept such proxy BU packets from the server.

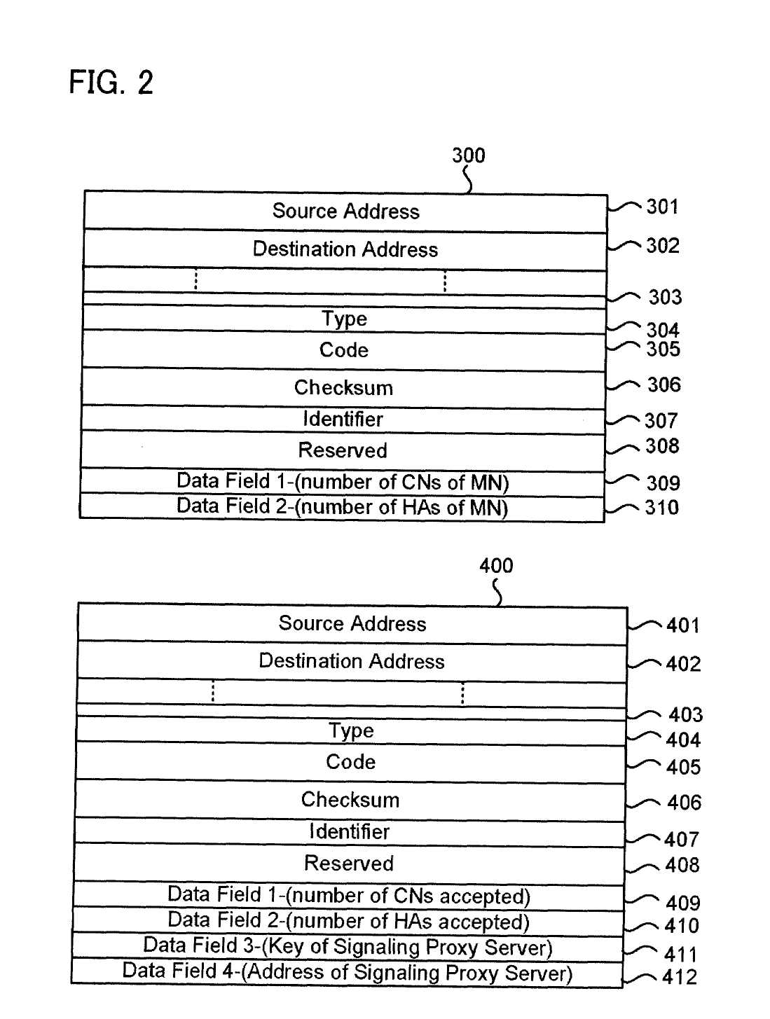

Next, the delegation request and delegation request a reply message structure is explained. FIG. 2 shows two types of messages. The top is the delegation request message 300 and the bottom is the delegation request reply message 400. These messages were used in FIG. 1. The delegation request message 300 can preferably have an Internet control message protocol version 6 (ICMPv6) type of message embedded in it. The source address 301 can be a link local address of MN or global Internet protocol version 6 (IPv6) address. The destination address 302 is the MR's address. This address can also either be the link local address or the global IPv6 address. Inside this message, the ICMPv6 message 303 is embedded. The type of this message given by the field 304 should be a new type that is used for such delegation establishment. The code of this message, which is field 305, can specify a delegation request type of message. The type value needs to be assigned by Internet assigned numbers authority (IANA). The message 303 will have the usual fields such as the checksum, identifier and reserved which are respectively shown as fields 306, 307 and 308 in FIG. 2. The checksum field 306 is used to detect whether the ICMP packet is corrupted. The identifier field 307 is used to match the request with the correct response. The reserved field 308 is used for further future minor modifications of delegation mechanism. Currently, the reserved field can be set to zero and ignored by the recipient. The delegation request message has two data fields 309 and 310. For the ICMPv6 delegation message of a particular type of code, which characterizes the delegation request, there will preferably be two data fields. The first field 309 carries the number of CNs the mobile node is communicating with. The second data field carries number of home agents the MN (i.e. multihomed MN) has. These values may be used by the MR to decide whether to allow the signaling proxy server to do proxy signaling for all the CNs and HAs or a part of those. For example, based on a total number of delegations to a particular signaling proxy server, MR can make such decisions. If many delegations have been made to a particular server, then for the purpose of load balancing among signaling proxy servers, all delegation requests on the CNs and HAs sent in the delegation request message may not be accepted by the MR.

The message 400 in FIG. 2 shows the delegation request reply message. This message 400 will also have the ICMPv6 type of message 403 embedded in it. The type of this ICMPv6 message will preferably be the same type as the delegation request message. Nevertheless, the code of this message given by field 405 will preferably be different from the code field 305 in message 300. The code field 405 indicates to the recipient the number of data fields attached to this message so that the message can be correctly received and interpreted. The source address 401 will be the MR's link local address or global address and the destination address 402 can be the MN's link local address or the MN's global address. There are four data fields for this code value. The first data field 409 gives the number of CNs to which the proxy-signaling mode can be established. The next data field 410 gives the number HAs to which proxy BU can be generated from the signaling proxy server. The data field 411 indicates the signaling proxy server's public key or some other secret key that can be used to create the certificate that needs to be passed to the HA of MN. Finally, the data field 412 gives the address of the signaling proxy server so that MN can readily prepare the delegation message for the server. It is advantageous when MN prepares this message than the MR because this reduces the burden of MR. Suppose MR has to do this for numerous MNs in its NEMO network, then the processing burden is very high for MR.

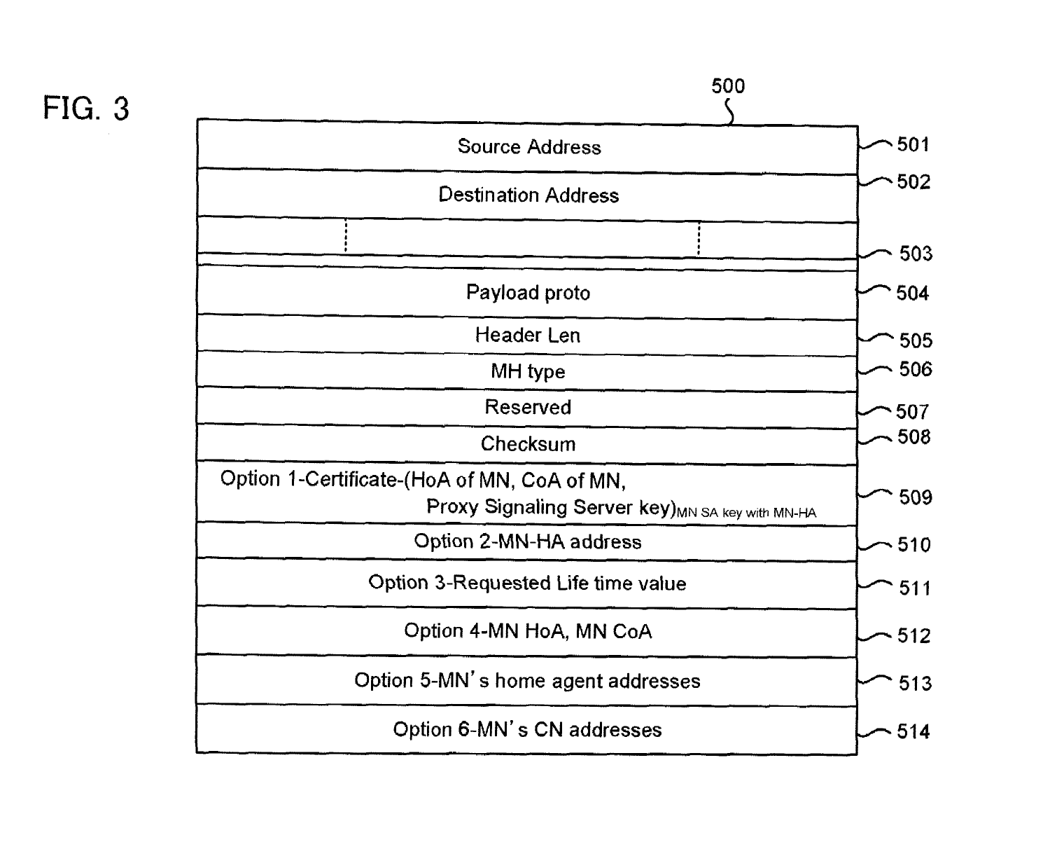

In another preferred embodiment a message structure of the delegation message originating from MN is given. FIG. 3 shows this delegation message structure 500. The delegation message 500 can preferably be a mobility header type of message 503. The source address 501 of the message will be MN's home address and the destination address 502 will be signaling proxy server address. If the MR constructs this delegation message then the message need not go via the MN-HA tunnel and the faster delegation of signaling rights can be achieved but this increases the processing burden at MR. The fields 504-508 characterizes the usual fields in the mobility header. The type field 506 will preferably need a new value to be assigned by IANA for such delegation purpose. There are preferably five mobility options of new types to be attached to this message. Such mobility options are necessary when the field contents are variable. The first option 509 has the certificate that is created by MN. This certificate is used by the signaling proxy server to generate the proxy BU message to the HA of MN. This certificate is preferably created by concatenating the home address of MN, the care-of address of MN and the proxy signaling server key and encrypting concatenated value using the key that was established between MN and MN's home agent. The next field 510 is also another option, which carries the MN's home agent address (perhaps the primary home agent or preferred home agent). This is required for the signaling proxy agent to construct the proxy BU packet that was discussed in FIG. 1. The third option given by 511 gives the lifetime value for which such delegation is valid. This is essential for the MN-HA to do the required tunneling to the signaling proxy agent as well the signaling proxy agent to do its proxy signaling. The next option 512 is the MN parameter option that has the MN HoA and MN CoA. This is required for the signaling proxy agent to construct the relevant HoTI and CoTI messages. The next option is the addresses of all the MN's home agents and is given by 513. This is required so that the signaling proxy agent can do the required proxy BU signaling. Finally, the option 514 gives all the addresses of the CNs that are communicating with MN to which the signaling proxy agent is going to generate the proxy RR signaling. It is important to note that the number of CNs and HAs accepted by MR in FIG. 2 will be the same as the number of home agent addresses and CN addresses found in the fields 513 and 514 respectively.

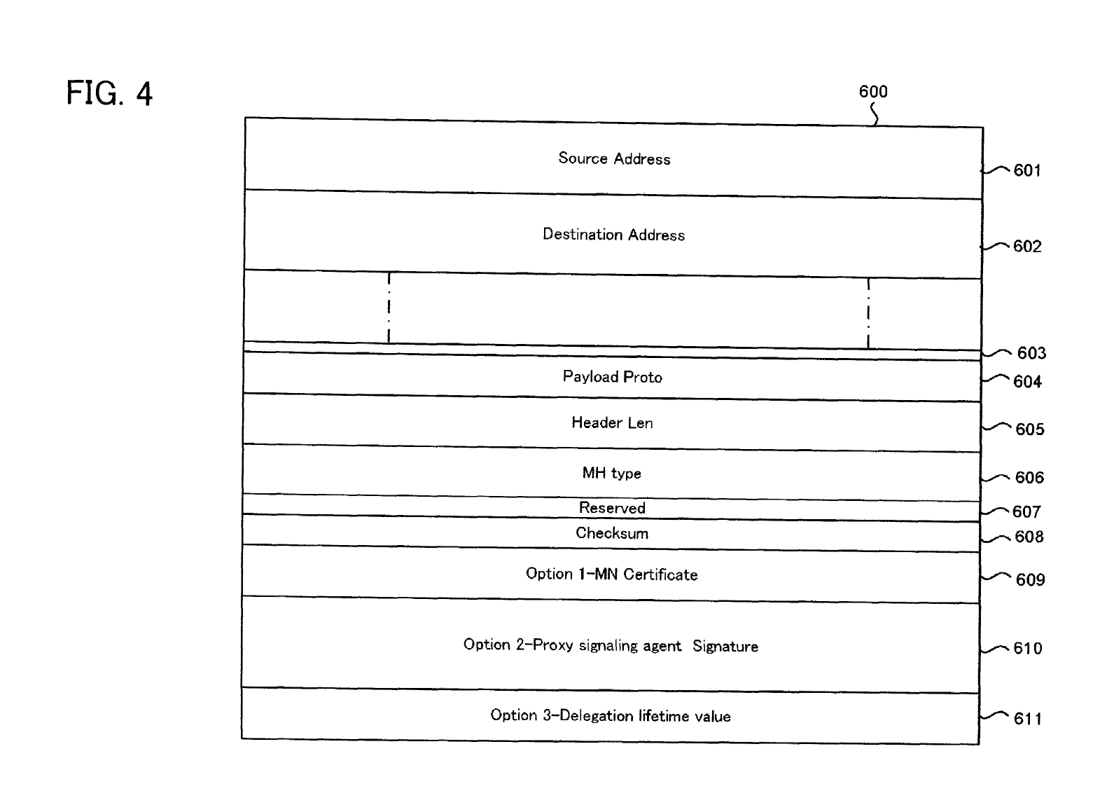

In yet another preferred embodiment of the present invention the message structure of the Proxy BU message sent from the signaling proxy server to the home agent of MN is described. FIG. 4 shows the proxy BU message 600. The source address 601 of the message may preferably be signaling proxy server address. The destination address 602 is the MN's HA address. The core security parameters that need to establish the binding between MN's HoA, MN's CoA and the signaling proxy server address are all embedded in a new mobility header 603. The mobility header is of a new type 606. The type value has to be assigned by IANA. The lifetime value of the proxy BU may be pre-configured and may not be explicitly sent in the message. A new mobility header is used because conventional BU requires home address destination option. In this case, such an option is not required and thus a new mobility header is used. The first mobility option 609 has the certificate issued by the MN. The second mobility option 610 has the signature from the signaling proxy agent. This signature can be created by encrypting some valid message using server private key or using some symmetric key. The last option in the header may preferably be the delegation lifetime option and is given as 610. This option is required to establish the delegation mode lifetime at the signaling proxy server and the MN's home agent. When this lifetime expires the server and the MN's home agent will revert back to normal operations unless the MN renews its delegation contract. When MN's home agent gets the certificate, it will decrypt it and then get the key associated with the server. It will then verify the signature to see the signature's validity using the obtained server key.

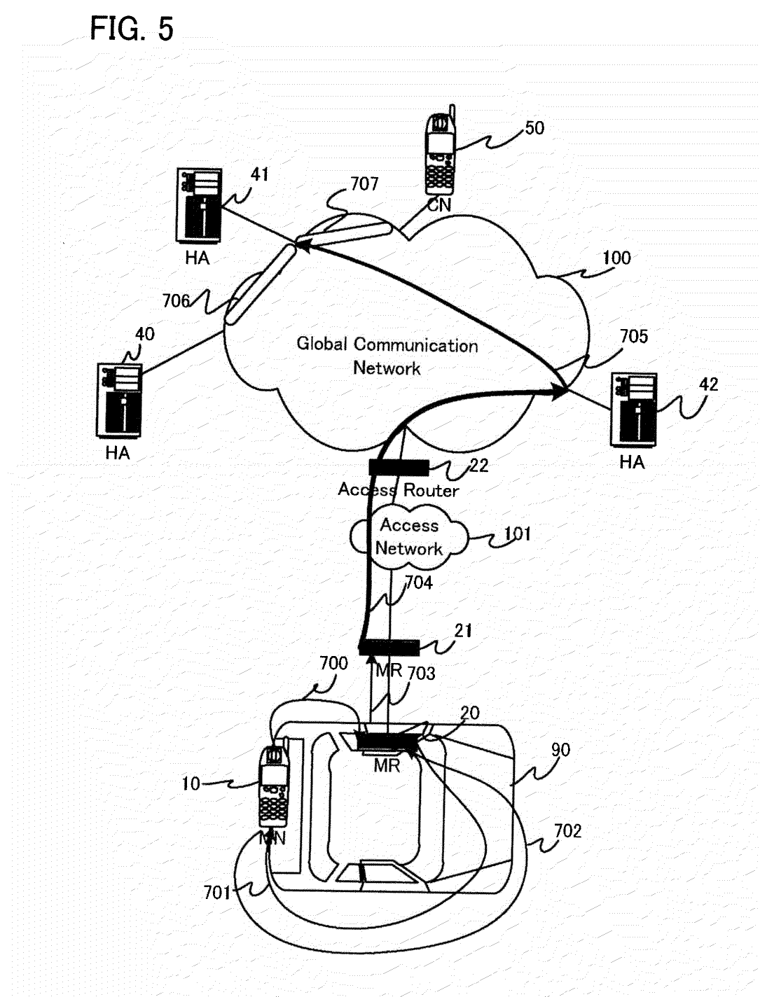

In another preferred embodiment of the present invention the signaling proxy server may preferably be the MR's home agent. The MR mentioned refers to the access router of MN. This is shown via a network or system diagram in FIG. 5. MN 10 is inside a vehicle 90 and it is connected to the internet 100 via MR 20. MR 20 is connected to the infrastructure via its access router MR 21. MR 21 is connected to the infrastructure via its access router AR 22. In the figure, HA 40, HA 41 and HA 42 are the home agents of MN 10, MR 20 and MR 21 respectively. It is assumed that MN 10 is communicating with CN 50. If MN decides to delegate its signaling rights away to some server (due to low power or due to efficiency) it can preferably send a delegation request message via 700 to MR 20. MR 20 then decides to further delegate this to its own home agent, which is HA 41. MR 20 will then send a positive reply via 701 to MN 10. MN 10 may then send the delegation message via 702 to MR 20. MR 20 may construct the delegation message to its home agent using the parameters sent by MN 10. In this scenario, MN 10 sends the message locally with the certificate and MR 20 constructs the mobility header embedded delegation message. This is to prevent the delegation message sent by MN 10 from going via its MN-HA tunnel.

MR 20 will construct the delegation message and then tunnel it via its home agent, which is HA 41. MR 21 will further tunnel this message and the encapsulated message will travel via 704 and will reach HA 42. The HA 42 will decapsulate and send the message via 705 to HA 41. HA 41 will decapsulate the message and get the relevant certificate. After that, HA 41 will send proxy BU to HA 40 and will receive the respective BA from HA 40 and the path 706 in FIG. 5 shows this. Similarly, HA 41 will perform the RR signaling with the CN 50 via the virtual path 707 shown in figure. A person skilled in the art would notice that the actual path would be slightly different from what is illustrated and appreciate that virtual path 707 is an abstraction for simplicity.

In the case that MN delegates the signaling rights to home agent of MR 20, it is important to understand that MN must derive its care-of address from the prefix that is obtained from home network of MR 20 and this care-of address is what will be given to CN 50. This is essential for the invention described in FIG. 5 to work. MN using MR's home prefix for care-of address configuration is useful in cases where there is rapid mobility. In such a case, it may not be preferable to get the prefix from the operator's network or foreign network.

The main advantage of delegating the signaling rights to the home agent of MR is that since the MN is inside the vehicle for long periods the delegation request need not change and long-term proxy signaling mode can be established. If the MN's CoA is derived from the home network prefix of MR, then MR's HA can directly intercept all the RR packets and the proxy RR signaling can be done quickly. It will be explained in future embodiments, this is useful in many scenarios including the global HA-HA and NetLMM scenarios.

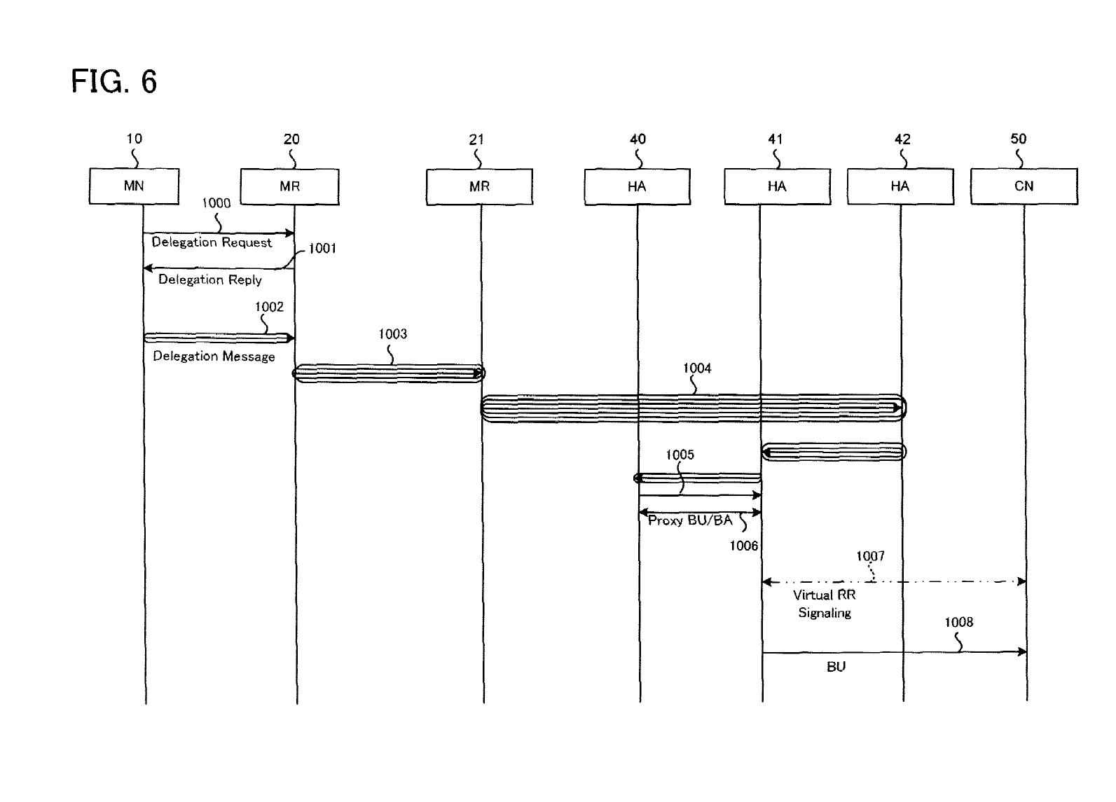

In yet another preferred embodiment of the main invention, there can be a scenario where the MN's signaling rights are delegated to its mobile router's home agent and the MN is deeply nested behind multiple MRs. The scenario is such that MN has simple MIPv6 implementation and the MRs have the standard NEMO Basic implementation. The signaling in this kind of scenario is shown in FIG. 6. Such a scenario may be common because route optimization and hand-off optimization are not required for all types of flows. Moreover, not all NEMO route optimization solutions have fully solved the security issues, hence such a scenario for less time critical but highly secret information may still be preferred.

In FIG. 6, MN 10 is nested behind MR 20 and MR 21. MN 10 configures its CoA from the prefix obtained from the home network prefix of MR 20. HA 40, HA 41 and HA 42 are the home agents of MN 10, MR 20 and MR 21 respectively. CN 50 is communicating with MN 10. MN 10 does the usual delegation request signaling as described previously. These are shown in FIG. 6 by the messages 1000 and 1001. In FIG. 6, MN 10 sends the delegation message directly to HA 41. Thus, MN 10 needs to encapsulate the delegation message in a tunnel 1002. This delegation message will travel via the paths 1003, 1004 shown and will go through further encapsulations before the message 1005 will finally reach HA 41. When HA 41 receives this message, HA 41 will get the relevant certificate. HA 41 will then establish the required binding with HA 40 by using message 1006. After that, RR signaling 1007 between HA 41 and CN 50 will take place. Finally, a BU 1008 will be sent to CN 50 from HA 41 to create the route optimization binding. This embodiment shows that such delegation of signaling mechanism can be deployed in such a scenario and no major issues arises as a result of this and also it shows that RR signaling is very much optimized as a result of such delegation in this scenario.

In yet another preferred embodiment of the main invention, there can be a scenario where the MN is nested behind a MR and the MN's signaling rights are delegated to its mobile router's home agent. The home agents of the MN and MR may be of distributed type and may form one single global HA-HA overlay network. As discussed previously, such a global HA-HA network is useful for HA hand-off optimization and RO with IPv6 type of CN. In the future, such networks may gain popularity due to growing demand from the aviation industry and this embodiment shows that the delegation mechanism can work in such a scenario and it is also efficient. In this scenario, MN is considered to have simple MIPv6 implementation and the MR is considered to have the standard NEMO Basic implementation. Furthermore, it is assumed that MN uses the prefix assigned to MR from its home network to configure its CoA.

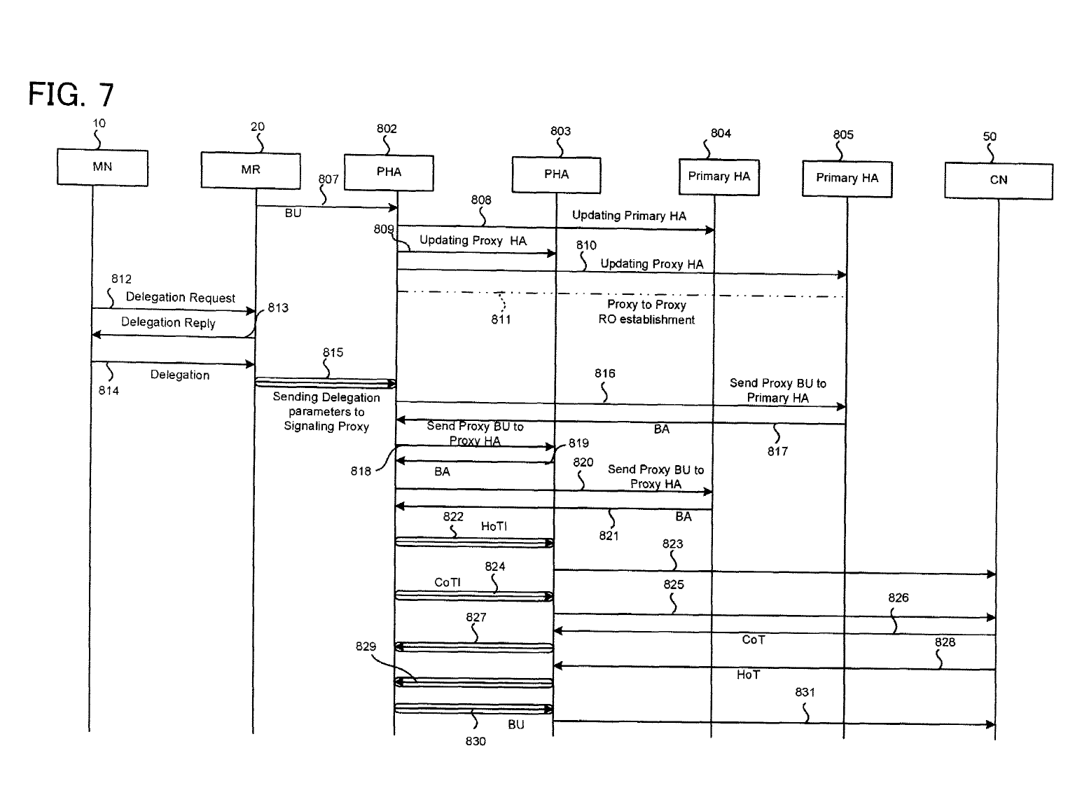

In FIG. 7, MN 10 is nested behind MR 20. The primary home agents for MN 10 and MR 20 are HA 805 and HA 804 respectively. Primary home agent refers to the home agent that is placed in the home network of the mobile node. The proxy home agents are PHA 802 and PHA 803 in FIG. 7. The primary HAs and the proxy HAs form one big global HA-HA overlay network. When MR 20 comes into a foreign network, it will send a BU 807 to its HA. Proxy HA 802 will intercept this BU 807. After that, this proxy HA will update the primary HA 804. Once the proxy HA 802 updates the primary HA 804 of the binding of MR 20, it will update all the other secondary HAs of such binding. This is shown as messages 809 and 810 in the FIG. 7. Once such binding is done, by using the message 811, the proxy HAs will send route updates in the overlay global HA-HA network using preferably border gateway protocol (BGP) so that correspondent router (CR) functionality can be attained via this global HA-HA network.

If MN 10 comes into the network attached to MR 20 and decides to delegate its signaling rights, it will perform the usual delegation request 812 and reply 813. Following that, it may construct the delegation message 814 and pass it on to MR 20 locally. MR 20 will send the delegation to its home agent. Proxy HA 802 will get the packet 815 and will act as the signaling proxy server. Since the home network of MN 10 is in the global HA-HA network, Proxy HA 802 may need to update (e.g. by sending proxy binding updates) all the MN's home agents including the proxy ones. The signaling proxy server 802 will first update primary HA 805 by using BU 816 and getting BA 817. Following that, proxy HA 802 will update the other two HAs in the network and these are shown as messages 818-821 in FIG. 7. Once this proxy BU is established, proxy-signaling server will need to perform the RR signaling with CN 50. It is assumed that the nearest proxy HA for CN 50 is the proxy HA 803. Proxy HA 803 will inject routes to reach MN 10 and the mobile network prefix of MR 20, so that proxy HA 803 can readily capture packets sent by CN 50 to MN 10.

Proxy HA 802 will construct the CoTI packet 824 using the CoA of MN 10 as the source address. To overcome ingress filtering, this has to be tunneled to a home agent in the overlay network that is close to CN 50. Proxy HA 802 has to do the same for the HoTI packet 822. These are shown as 822-825 in FIG. 7. Similarly HoT 828 and CoT 826 sent by CN 50 will be intercepted by proxy HA 803 and will be tunneled to the proxy-signaling agent, which is proxy HA 802. These are shown in FIG. 7 by messages 826-829. Following these RR exchanges, the proxy HA 802 can form the necessary binding key using the RR tokens and send the BU 830 to CN 50. In this overlay HA-HA environment, BU 830 has to be encapsulated to overcome ingress filtering. From this embodiment one can clearly see that the signaling right delegation mechanism where the MR-HA is the signaling proxy can work in the global HA-HA scenario. It is easy to appreciate to one skilled in the art that the delegation mechanism has improved the RR signaling in the global HA-HA network.

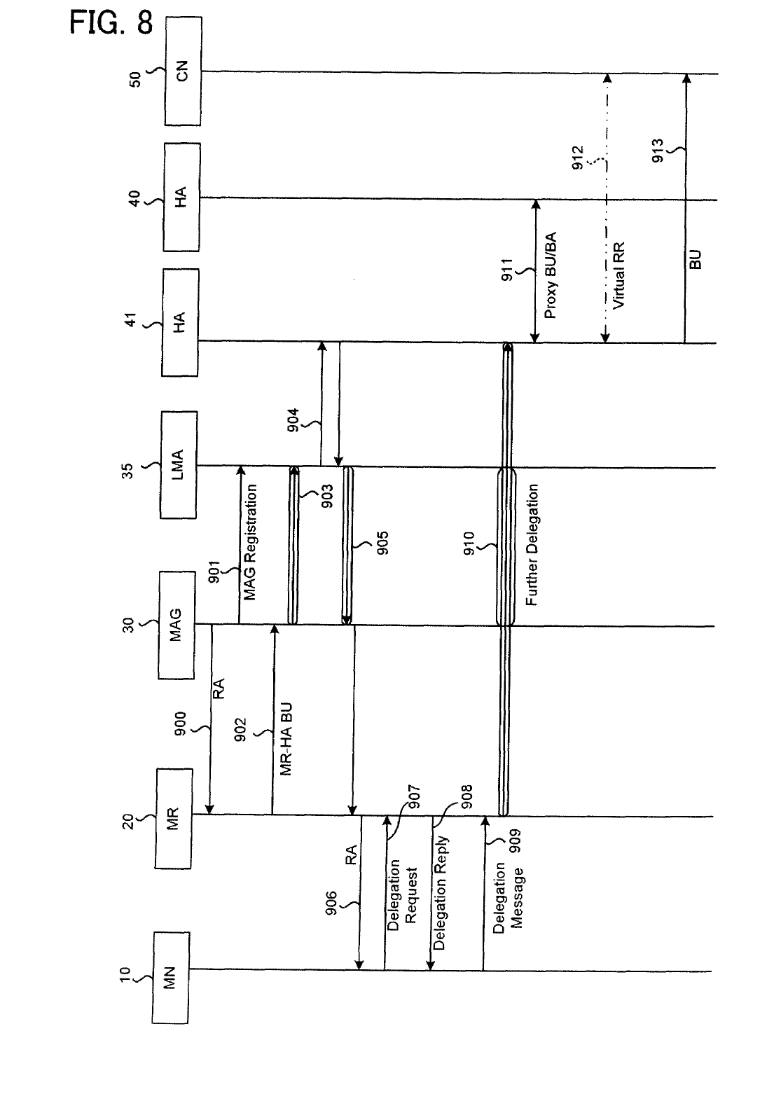

In yet another preferred embodiment of the present invention there can be a scenario where the MN is nested inside a NEMO and the NEMO is roaming in a NetLMM domain and the home agent of the MR is the signaling proxy agent. The delegation mechanism can work in this scenario, as will be described in this embodiment. FIG. 8 shows the signaling that will take place in this environment. MN 10 is connected to MR 20 that is situated in a foreign link. MAG 30 is the mobile access gateway, which is similar to an access router. LMA 35 is called the local mobility anchor and it is similar to the MAP. HA 40 and HA 41 are the home agents of MN 10 and MR 20 respectively. MN 10 is having data communication with CN 50.

MR 20 may enter the NetLMM domain and receives the router advertisement (RA) 900 from MAG 30. The prefix advertised in this RA message 900 will be the prefix used for NetLMM services and MR 20 will configure a care-of address from it. After that, the MAG 30 will register this CoA with LMA 35 and will inform the LMA 35 that this address can be reached via itself. Following that, MR 20 will want to send a BU to its HA which is HA 41. This BU packet will have a single level of tunnel from MAG 30 to LMA 35 as shown in FIG. 8. This tunneled packet 903 will be decapsulated at LMA 35 and will reach HA 41.

Now, MN 10 may receive a RA 906 from MR 20. The prefix advertised here might well be the prefix MR 20 obtained from its home network. MN 10 configures its CoA and does the usual delegation request signaling, shown as 907 and 908 in FIG. 8. After a positive reply from MR 20, MN 10 can pass the certificate to MR 20 and MR 20 can construct the delegation message 910 and pass it on to its HA. This message 910 will be tunneled from MR 20 and will further have a short tunnel in the NetLMM domain as can be seen from FIG. 8.

Once HA 41 receives this delegation message 910, it will send the necessary proxy BU 911 to HA 40. Following that, HA 41 will perform the RR procedure with CN 50, as indicated by 912 in FIG. 8. Finally, HA 41 will send BU 913 to CN 50. It is clear from these that the delegation mechanism can be used in the NEMO NetLMM scenario and can be very useful because fast RR can be established.

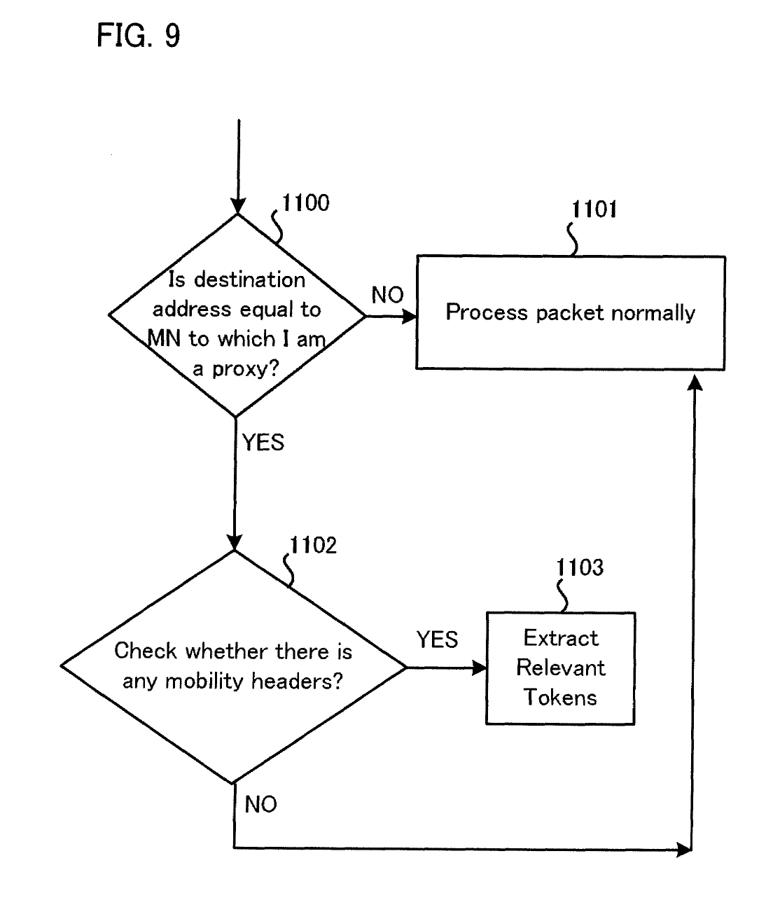

In another preferred embodiment of the current invention, packet-processing mechanism at packet reception involved with the signaling proxy agent is described. It is important to understand, when MN's mobile access router delegates the signaling rights to its own HA, the HA only does the proxy RR signaling. This signaling proxy agent does not process data packets. FIG. 9 shows a simple processing loop associated with the signaling proxy. At step 1100, the signaling proxy agent will check the destination address of the packet. If the destination address is equal to the address to which it is a proxy for example MN's CoA, it will then go to step 1102. If step 1100 evaluates to false it will pass the control to step 1101 where the packet will be routed normally using normal implementations. If step 1100 evaluates to true then the control goes to step 1102. Here it is checked whether there are any mobility headers present. If there is any mobility header present and consequently step 1102 evaluates to true, then the process given by step 1103 will be performed. This process 1103 gets the relevant RR tokens and will be used to generate the binding key with CN. If step 1102 evaluates to false then the packet will be routed normally and control will be passed to step 1101. If the packet is to MN and there is no mobility headers, then that implies it could well be a data packet and hence this packet will be passed using normal routing mechanisms to MN.

In the above description, the signaling proxy agent can be any node along the path from CN to MN. In particular, a person skilled in the art would appreciate that the signaling proxy agent can be the HA of the MR.

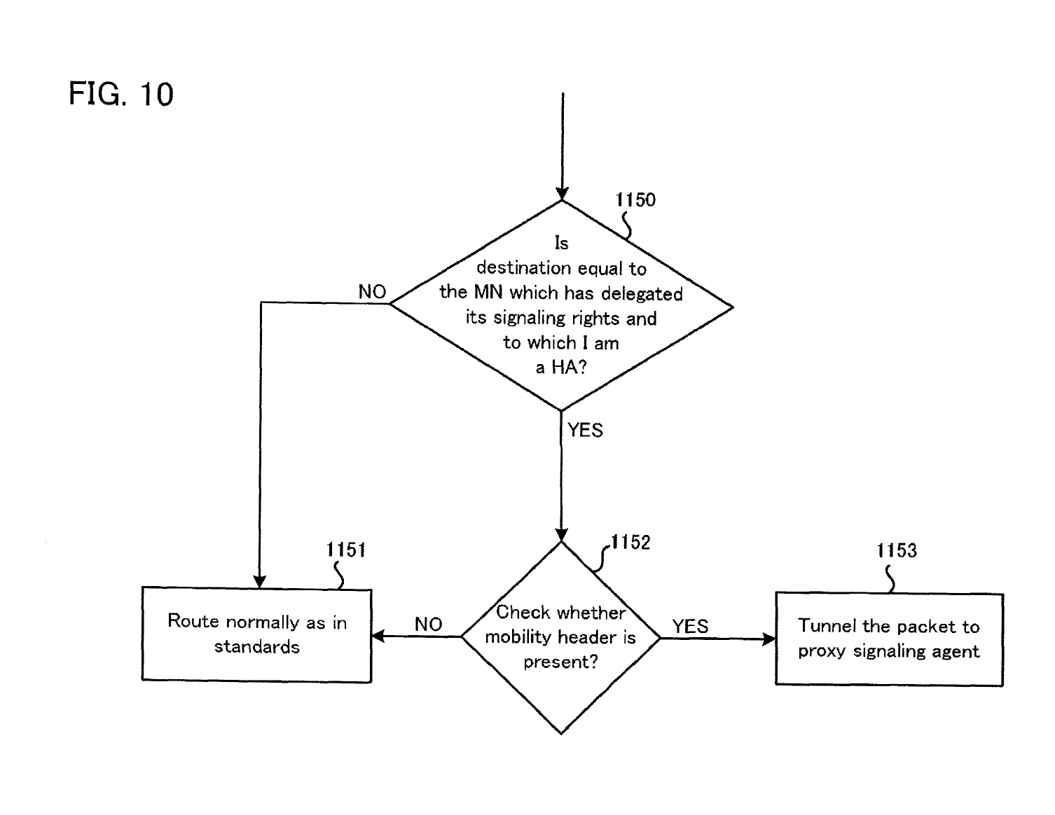

In yet another preferred embodiment of the present invention the packet processing mechanism at the home agent of MN is described. Here, MN refers to the node that has delegated its signaling rights to some server in the fixed infrastructure. The home agent of MN needs to have some small changes to support this delegated signaling mechanism. The steps involved in MN's HA are described in FIG. 10. When MN's HA intercepts a packet, it will first check the destination address, as shown by step 1150, to see if the destination belongs to a MN which has currently delegated its signaling rights to a server. If step 1150 evaluates to false then step 1151 will be performed where the packet will be routed normally using normal routing implementations. If step 1150 evaluates to true then step 1152 is performed. In step 1152, it will be checked whether there is any mobility header present. If there is (for example HoT), the packet will be tunneled to the signaling proxy agent. If 1152 evaluates to false then the step 1151 will be performed and the packet will routed normally via normal mechanisms. For one skilled in the art it can be seen that the changes required at MN's home agent, which delegated away its signaling rights, is not much and it is favorable.

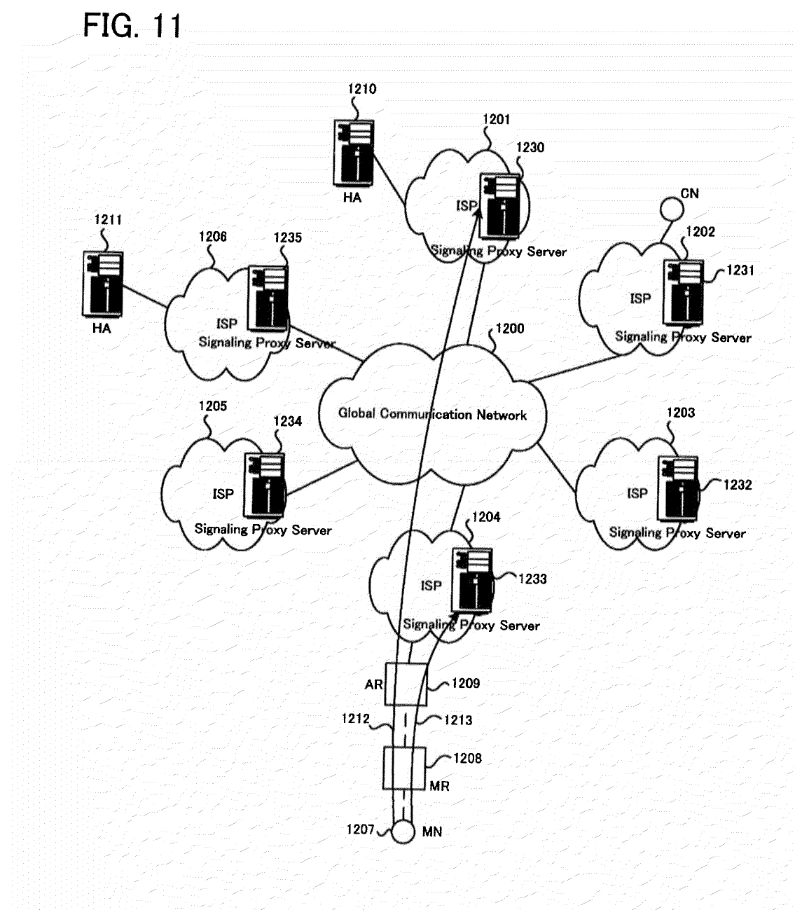

In another preferred embodiment of the present invention, special signaling proxy servers exclusively for this proxy signaling purpose can preferably be deployed all over the infrastructure and can be discovered using care-of address of MN. A system or network diagram in FIG. 11 shows this. The global communication network 1200 is connected to many ISPs 1201 to 1206. As can be seen, in each ISP there is an explicitly placed signaling proxy agent for doing such proxy signaling and these are shown as 1230 to 1235 in the FIG. 11. MN 1207 is nested behind MR 1208. MR 1208 is attached to AR 1209. The home agents of MN 1207 and MR 1208 are HA 1211 and HA 1210 respectively. It is easily understood by one skilled in the art that the proxy server functionality can be implemented in any fixed router in the router hierarchy.

There are some scenarios where the MN 1207 would configure a care-of address from the mobile network prefix of MR 1208 which was obtained from the home network of MR 1208 and there are some other scenarios where MN 1207 would configure care-of address from a prefix given by AR 1209. There are some schemes that use the prefix obtained from the foreign domain and configures the care-of address and gives this address to the CN. Many NEMO RO schemes are doing this and hierarchical mobility management schemes are also doing this. As mentioned in a previous embodiment, there are some NEMO RO schemes that use the care-of address derived from MR's prefix given from its home network. An ideal proxy-signaling scheme should work for both prefix configuration methods so that solution is valid in any future system.

In this method, MN 1207 using its CoA can construct a suitable anycast address to trace the signaling proxy server. MN 1207 can find its own signaling proxy server or can ask MR 1208 to find one. If MN 1207 configures a care-of address from the prefix delegated by AR 1209, the signaling proxy server it finds will be the one in ISP 1204. The signaling message 1213 shows this server discovery. If the MN 1207 CoA is obtained from MR home network then the server discovered will be from ISP 1201 as shown in the figure. The signaling message 1212 will be used for this discovery.

When compared to the previous method, this has some advantages and some disadvantages. The advantage is that it can work in any scenario irrespective of which prefix the MN uses to configure its care-of address. Similar to the previous mechanism where MR's HA is the signaling proxy, this discovered signaling proxy server can also easily intercept CoT packets and also generate CoTI packets overcoming ingress filtering. This is possible because the signaling server is discovered using the MN's CoA and hence the server is in the path that can directly intercept the CoT packets and can generate CoTI packets using MN's CoA. The main issues with this mechanism are that it depends where this signaling server is placed. If it is not in the default path towards MN CoA prefix, then it needs to inject routes to intercept the CoT packets. Another problem is that such explicit signaling server needs to be deployed throughout which may be costly. Nevertheless, if such MN mobility patterns are common in the future (i.e. MN being embedded in a mobile network for long periods) then the deployment cost is more than covered by the signaling efficiency this scheme can bring.

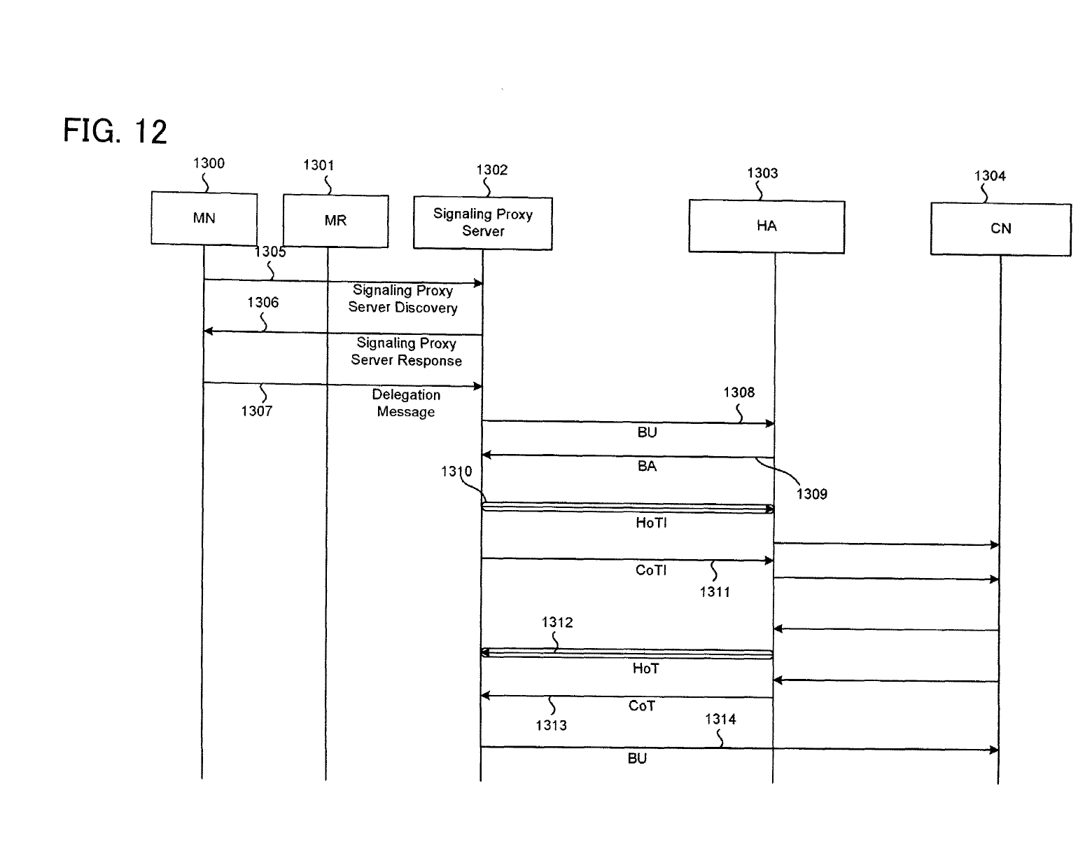

In another preferred embodiment of the present invention the delegation discovery of the signaling proxy agent using the anycast method as well the proxy BU and proxy RR signaling is explained. FIG. 12 shows such delegation discovery as well as proxy mode signaling operation. MN 1300 is nested behind MR 1301. The signaling proxy server is given as 1302. HA 1303 is the home agent of MN 1300. CN 1304 is the node with which MN 1300 is communicating. MN 1300 configures a CoA using any prefix and generates an anycast address to find the suitable server directly related to the CoA's prefix. By doing this, a server that can easily intercept CoT and generate CoTI using CoA of MN 1300 can be discovered. MN 1300 generates signaling proxy server discovery message 1305 and it will reach the server 1302. The server 1302 will then send a positive reply as shown by 1306. Following that, MN 1300 sends the proper delegation message 1307 with relevant certificate to server 1302. Server 1302, as described previously, will send the proxy BU 1307 and receive BA 1308 from HA 1303. Following that, server 1302 will engage in RR procedure with CN 1304. Packets 1310 to 1313 in FIG. 12 show these. Finally, signaling proxy server 1302 will send BU 1314 to CN 1304. Alternatively, MR 1301 can perform the proxy discovery using the anycast method. In this case, it can use the anycast type of discovery or a suitable signaling proxy server can be given to MR using some trusted anchor.

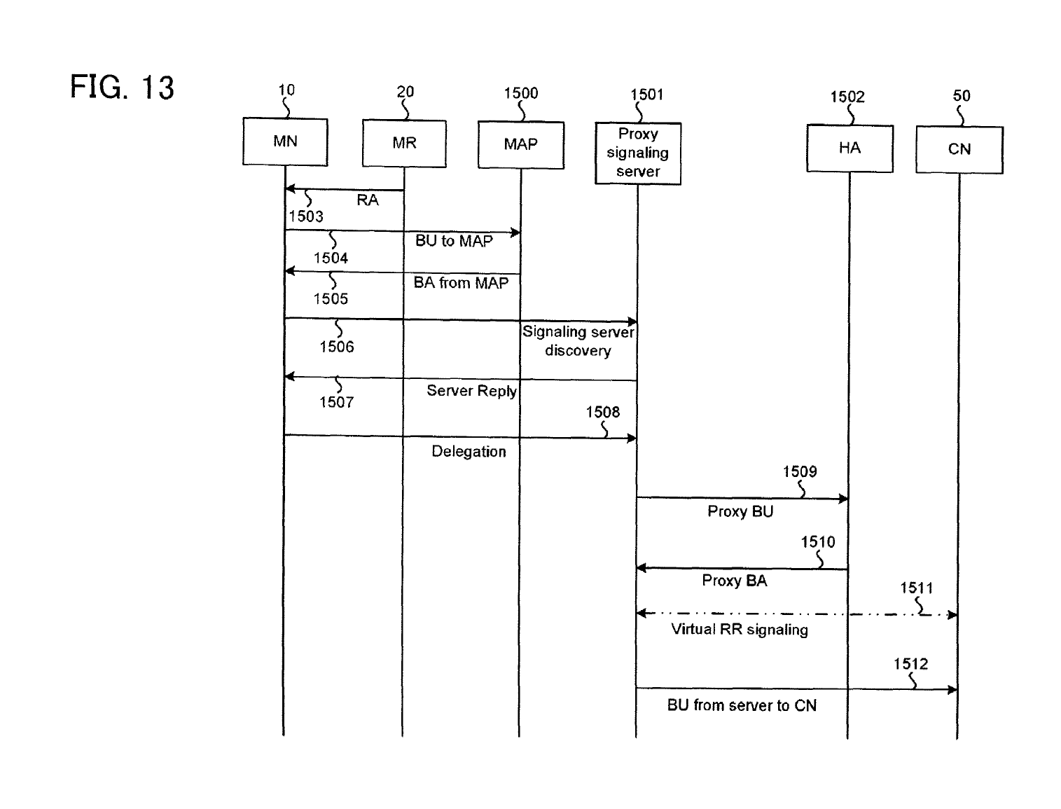

In yet another preferred embodiment of the present invention, discovering the suitable signaling proxy server using the anycast address method in a NEMO HMIPv6 scenario is described. In FIG. 13, MN 10 is nested behind MR 20. HA 1502 is the home agent of MN 10 and MN 10 is having data communication with CN 50. MR 20 sends a RA 1503 where the MAP option attached to the RA gives the MAP 1500 address. MN 10 will configure two care-of addresses. One is the local care-of address (LCoA) configured using the prefix obtained from the home network of MR 20. Another is the regional care of address (RCoA) configured from a prefix handled by MAP 1500. After such address configuration, MN 10 will send BU 1504 to MAP 1500. This allows MN 10 to register a binding between MN's local care of address and the regional care of address at MAP 1500. MAP 1500 responds to BU 1504 with a BA 1505. MN 10 then informs CN 50 the regional care-of address as its care-of address. Thus, MN 10 will use the RCoA prefix in constructing the anycast address for the signaling proxy server discovery. The message 1506 will be sent and the server 1501 in the MAP domain will respond. Following that, MN 10 sends the delegation message 1508 with the certificate. Following that the signaling proxy server 1501 will send the proxy BU 1509 to HA 1502. Following which the signaling proxy server 1501 will initiate the RR procedure with CN 50. This is shown as 1511 in FIG. 13. Finally, the signaling proxy server 1501 will send the BU message 1512 to CN 50.

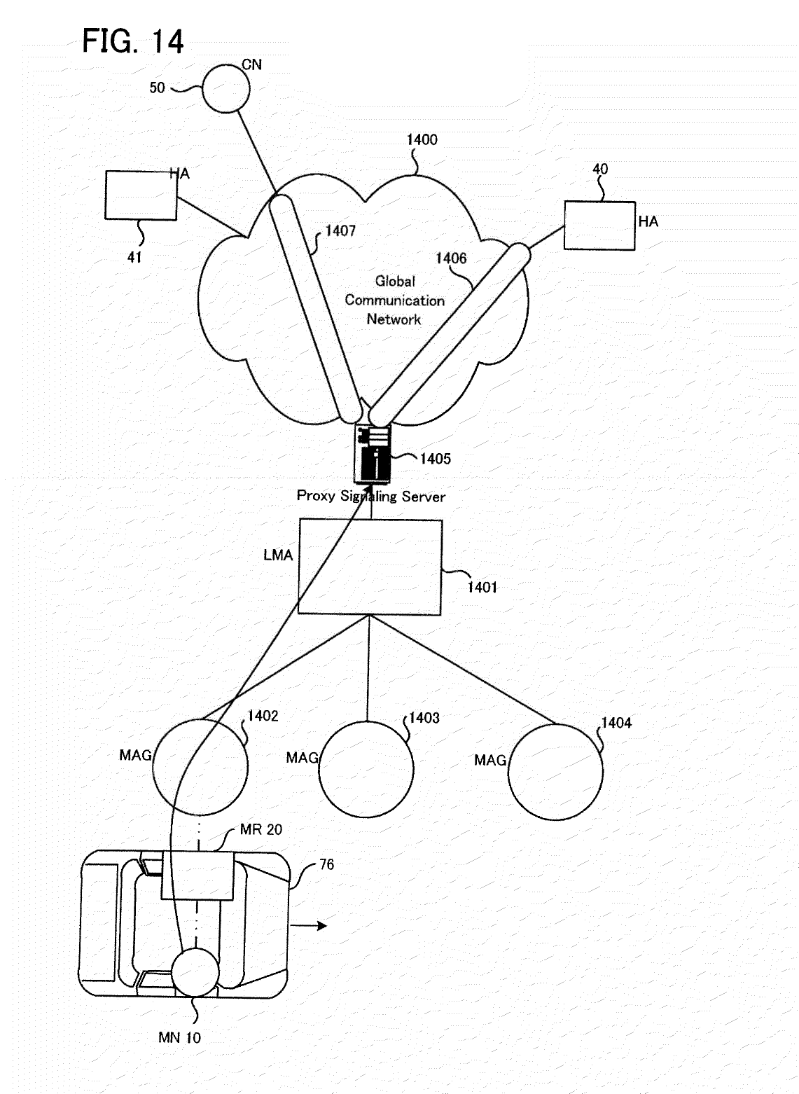

In yet another preferred embodiment of the present invention, discovering the suitable signaling proxy server using the anycast address method in a NEMO NetLMM environment is described. FIG. 14 shows such a discovery in the NEMO NetLMM scenario. MN 10 is nested behind MR 20. MR 20 is placed in the car 76. HA 40 and HA 41 are the home agents of MN 10 and MR 20 respectively and CN 50 is having a data communication with MN 10. The LMA 1401 defines the NetLMM domain and there are many MAGs such as 1402, 1403 and 1404 under the NetLMM domain. The global communication network is shown as 1400. MN 10 configures a CoA from the prefix given to MAG 1402 by LMA 1401. In this case, the anycast based server discovery will locate the server 1405. Once this server, i.e. server 1405, is found, the server will establish BU/BA with HA 40 via 1406 and will perform proxy RR signaling with CN 50 via the virtual path 1407.

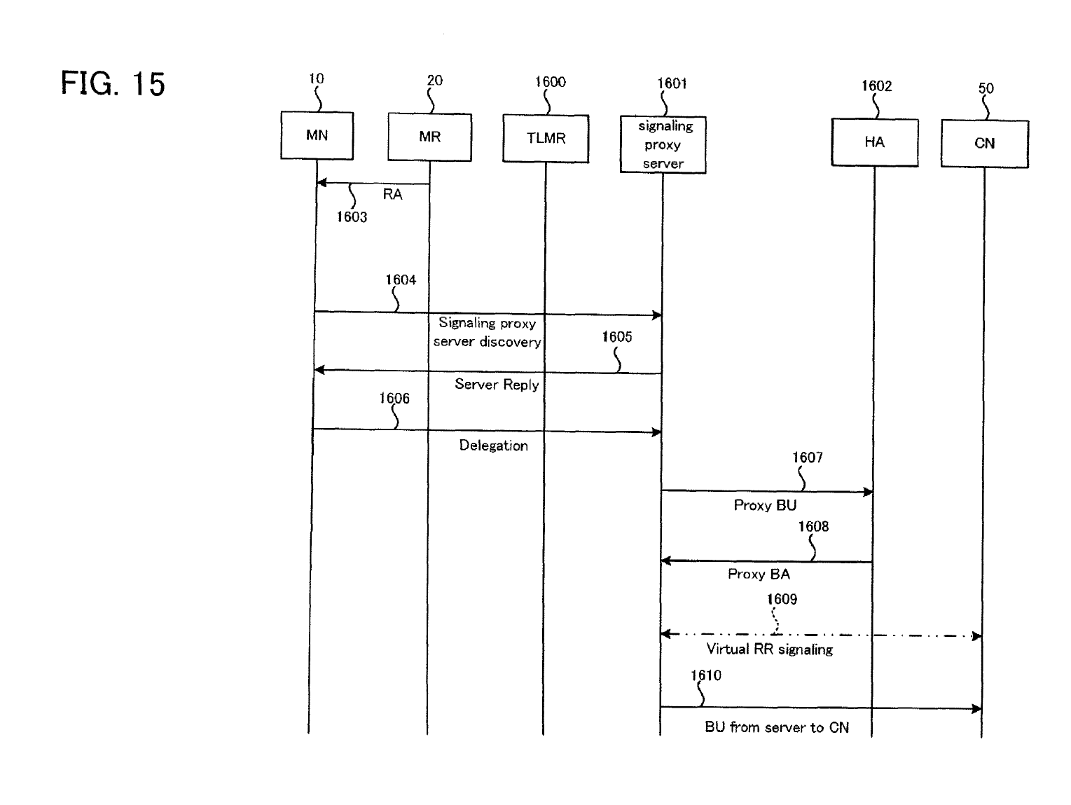

In another preferred embodiment of the present invention the anycast type of server discovery can take place in a NEMO RO scenario where the care-of address given to CN can preferably be the Top Level Mobile Router's (TLMR) CoA. This is illustrated in FIG. 15. In FIG. 15, MN 10 is nested behind MR 20 and MR 20 is nested behind TLMR 1600. The home agent of MN 10 is HA 1602 and MN 10 is having a data communication with CN 50. MR 20 sends a RA 1603 to MN 10 and MN 10 configures a CoA from the prefix advertised. This prefix can be obtained from the home network of MR 20. Nevertheless for RO purpose, MN 10 may inform CN 50 the CoA of TLMR 1600 as its own CoA. In this case, MN 10 will use this CoA prefix to locate its suitable signaling proxy server. Thus the server 1601 will be in the domain that TLMR 1600 is attached to. The signaling delegation messages are shown as 1604 to 1606 in the FIG. 15. After such delegation, the proxy BU/BA messages are exchanged and these messages are shown as 1607 and 1608 in the FIG. 15. Finally, after this BU/BA exchange with HA 1602, the signaling proxy server 1601 will initiate RR procedure with CN 50 and this is shown as 1609 in the FIG. 15. Following that, signaling proxy server will exchange BU message 1610 to CN 50. In another preferred embodiment of the present invention, the BU from the signaling server (can be discovered using anycast method or be the MR's HA) to the MN's HA can be done fully transparently so that there are no changes required at MN's HA. MN here refers to the mobile that has delegated its signaling rights. The only disadvantage is that if this is the case, the HoT packets will be sent to MN's CoA and the signaling server may need to look whether it is the mobility header to extract the relevant HoK token. Furthermore, the home address destination option field needs to be present in the BU message sent from signaling proxy server to the MN's HA.

Although the invention has been herein shown and described in what is conceived to be the most practical and preferred embodiment, it will be appreciated by those skilled in the art that various modifications may be made in details of design and parameters without departing from the scope and ambit of the invention.

Though it is assumed that there is a mobile network (or a hierarchical mobile network) consisting of a mobile router (and nodes therein) in the above embodiments, the present invention can be applied to Local Mobility Management environment.

For example, PMIP (Proxy Mobile IP), which is one of Local Mobility Management methods, provides mobility support for a mobile terminal by registering a moving mobile terminal at LMA (Local Mobility Anchor) by MAG (Mobile Access Gateway), and MR in this description can be adapted to be equivalent for MAG. In this case, it is considered that MR's HA may be equivalent for LMA. Furthermore, hierarchical mobile network may be equivalent for such a case that a network operator, providing a network which uses PMIP, uses multiple MAG-LMA tunnels constituted by PMIP due to roaming association.

In addition, local network domain architectures may be various due to roaming association among plural operators, etc. For example, it is considered that MAG is not only an access router for a mobile node, but also an edge router for a different access network (including roaming) and, after connecting to the different access network once, the mobile node connects via the different access network to MAG which is the edge router. It is also obvious that the operation of a signaling proxy server according to the present invention can be applied to the above case though there are differences in design matters such as various parameters, access procedures to MAG or communication procedures.

Each of the functional blocks and procedures used in the description of the embodiments of the present invention can be realized as LSI (Large Scale Integration), which is typically represented by an integrated circuit. These may be manufactured individually as one chip or may be manufactured as one chip including a part or all. Here, it is referred as LSI, while it may be called IC (Integrated Circuit), system LSI, super LSI or ultra LSI depending on the difference in the degree of integration.

The technique to produce the integrated circuit is not limited to the technique of LSI, and it may be realized as a special-purpose circuit or a general-purpose processor. After the manufacture of LSI, FPGA (Field Programmable Gate Array) or reconfigurable processor may be used, in which the connection and the setting of circuit cells inside LSI can be reconfigured.

Further, with the progress in the semiconductor technique or with the emergence of other technique derived from it, if a new technique of circuit integration to replace LSI may appear, the functional blocks may naturally be integrated by using such technique. For instance, the adaptation of biotechnology may be one of such possibilities.

### INDUSTRIAL APPLICABILITY

The present invention has the advantage of reducing location update signaling for MN that is nested inside a NEMO network for long periods, and can be applied to the field of packet-switched communication.

1. A system of communication nodes in a packet switched data communication network including one or more mobile nodes, one or more mobile routers, one or more home agents of said mobile node and said mobile router and a certain router with signaling proxy server functionality:
wherein said mobile node delegates signaling rights of said mobile node to said router with signaling proxy functionality,
wherein said router with signaling proxy functionality is located on a path via which said mobile node receives a care-of test packet from a correspondent node of said mobile node, and
wherein said router with signaling proxy functionality can generate a care-of test init packet using a care-of address of said mobile node, said care-of address overcoming ingress filtering.

2. The system of communication nodes in a packet switched data communication network according to claim 1,
wherein said router with signaling proxy functionality sends said generated care-of test init packet as a return routability signaling to said correspondent node as a signaling proxy for said mobile node, and
wherein said router with signaling proxy functionality performs location management signaling to a home agent of said mobile node as a proxy for said mobile node.

3. The system of communication nodes in a packet switched data communication network according to claim 1,
wherein said mobile node sends a delegation request message for delegating said signaling rights of said mobile node to said mobile router which said mobile node is directly connected to, and
wherein said delegation request message has a number of correspondent nodes which said mobile node is communicating with and a number of home agents of said mobile node.

4. The system of communication nodes in a packet switched data communication network according to claim 3, wherein said mobile router which has received said delegation request message sent from said mobile node, decides on a number of correspondent nodes and home agents to which said signaling proxy server can be assigned, based on a number of delegation maintained in data base entries of said mobile router, and informs said mobile node of these values with identifiers of signaling proxy servers by a reply to said delegation request message.

5. The system of communication nodes in a packet switched data communication network according to claim 4, wherein, in case that said mobile node has received a positive reply to said delegation request message from said mobile router,
said mobile node sends a delegation message to said signaling proxy server informed by said mobile router.

6. The system of communication nodes in a packet switched data communication network according to claim 5, wherein a certificate included in said delegation message can have a value which is a cryptographic cipher created using a home address of said mobile node, a care-of address of said mobile node and a public key of a signaling proxy server encrypted by a key which said mobile node shares with said home agent of said mobile node.

7. The system of communication nodes in a packet switched data communication network according to claim 6, wherein said signaling proxy server sends a proxy BU which is said location management signaling to said mobile node, said proxy BU including said certificate received from said mobile node, a signature and a lifetime of said delegation.

8. The system of communication nodes in a packet switched data communication network according to claim 1, wherein said signaling proxy server is said home agent of said mobile router of said mobile node.

9. A router with signaling proxy functionality in a packet switched data communication network including one or more mobile nodes, one or more mobile routers, one or more home agents of said mobile node and said mobile router and a certain router with signaling proxy server functionality, comprising:
means for accepting delegation of signaling rights of said mobile node from said mobile node,
means for receiving a care-of test packet from a correspondent node of said mobile node, and
means for generating a care-of test init packet using a care-of address of said mobile node, said care-of address overcoming ingress filtering.

10. The router according to claim 9, comprising:
means for sending said generated care-of test init packet as a return routability signaling to said correspondent node as a signaling proxy for said mobile node, and
means for performing location management signaling to a home agent of said mobile node as a proxy for said mobile node.

11. The router according to claim 9, comprising:
means for receiving a delegation message from said mobile node, and
means for sending a proxy BU which is said location management signaling to said home agent of said mobile node, said proxy BU including a certificate of said mobile node, a signature and a lifetime of said delegation which have included in said delegation message.

12. The router according to claim 9, wherein said router of signaling proxy functionality is said home agent of said mobile router of said mobile node.

13. A mobile node in a packet switched data communication network including one or more mobile nodes, one or more mobile routers, one or more home agents of said mobile node and said mobile router and a certain router with signaling proxy server functionality, comprising means for sending a delegation request message for delegating signaling rights to said mobile router which said mobile node is directly connected to,
and characterized in that said delegation request message has a number of correspondent nodes which said mobile node is communicating with and a number of home agents of said mobile node.

14. The mobile node according to claim 13, comprising,
means for, in case of having received a positive reply to said delegation request message from said mobile router, sending a delegation message to said signaling proxy server based on a identifier of said signaling proxy server included in said reply.

15. The mobile node according to claim 14, wherein a certificate included in said delegation message can have a value which is a cryptographic cipher created using a home address of said mobile node, a care-of address of said mobile node and a public key of said signaling proxy server encrypted by a key which said mobile node shares with said home agent of said mobile node.

16. A mobile router in a packet switched data communication network including one or more mobile nodes, one or more mobile routers, one or more home agents of said mobile node and said mobile router and a certain router with signaling proxy server functionality, comprising:
means for receiving a delegation request message sent from said mobile node, and
means for deciding on a number of correspondent nodes and home agents to which said signaling proxy server can be assigned, based on a number of delegation maintained in data base entries, and informing said mobile node of these values with identifiers of signaling proxy servers by a reply to said delegation request message.
